(19) United States
(12) Patent Application Publication
(10) Pub. No.: US 2006/0090021 A1
(43) Pub. Date: Apr. 27, 2006

(54) PC managed networked audio bell/intercom system

(76) Inventor: Terry Daniel Weidig, Austin, TX (US)

Correspondence Address: Terry D. Weidig, 13113 Rochester Ln., Austin, TX, 78753, US

(21) Appl. No.: 10/974,445

(22) Filed: Oct. 27, 2004

(51) Int. Cl. G06F 13/38

(52) U.S. Cl. 710/62

(57) ABSTRACT

A bell and intercom system consisting of a Controller PC with software which sends instructions across a computer network to client PCs and network audio devices. System plays audio at client PCs and network audio devices at scheduled times or in real-time. The controller PC software consists of modules for scheduling audio, configuring clients PCs and network audio devices, and for broadcasting audio in real-time to the client PCs and network audio devices. The system allows multiple clients to be grouped into zones to play audio to a set of clients. Client PCs are personal computers which include a client software application which plays audio when instructed by the Controller PC. Network audio devices are devices which attach to the network and play audio when instructed by the Controller PC.

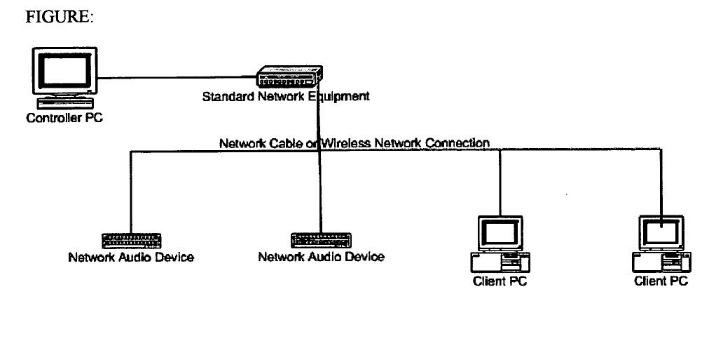

### CROSS-REFERENCE TO RELATED APPLICATIONS

Not Applicable

### FEDERALLY SPONSORED RESEARCH

Not Applicable

### SEQUENCE LISTING OF PROGRAM

Not Applicable

### BACKGROUND OF THE INVENTION

1. Field of Invention

This invention relates to intercom/bell systems, specifically to such technologies to provide automation and control of audio across such systems.

2. Description

The invention, an improved bell/intercom system, is a computer-driven system which plays audio to multiple devices over a standard network. The system is an improvement over previous bell/intercom systems through its use of standard TCP/IP network architecture and a PC driven management system. The system includes one or more personal computers connected via a network to networked audio devices. The networked audio devices are installed at locations corresponding to zones on a standard intercom system. The networked audio devices may be stand-alone devices which play audio or personal computers including, but no limited to, desktop and laptop computers. The controller computer in the system is a personal computer and may be installed with any standard operating system including Microsoft Windows, Linux, or Apple OS X. The computer acts as a controller which directs audio to the networked audio devices. The computer runs a special software application which provides operators an interface to the system scheduler, intercom functions, and administrator functions. The computer software includes functions to send audio to devices, to schedule audio, to define zones consisting of multiple

### OPERATION

In operation, the system performs the following functions:

1. Schedule Audio Broadcast—the controller computer transmits commands to one or more networked audio devices to play audio at a scheduled time.
2. Intercom Function—the controller computer allows operator(s) to speak into a microphone and have audio transmitted to one or more networked audio devices.
3. Device Status Transmission—the controller computer polls the networked audio devices and retrieves a status from each device. The status is displayed through the controller computer software's user interface.
4. Zone Definition—the controller computer software allows operators to define zones, which consist of one or more networked audio devices. The zones are used by the Scheduled Audio Broadcast and Intercom Functions to determine where to play audio.

I claim:

1. A system for distributing audio to devices and/or PCs over a computer network for a school bell or intercom system comprising:
a) A computer server (controller PC) with software which is able to manage audio across the computer network to network audio devices on the network.
b) The controller PC is any personal computer or server including desktop personal computers, portable computers, servers, and PDA systems.
c) The computer network is any computer network, including local Ethernet networks, wide area networks, and the Internet.
d) Each network audio device is one of the following:
a. A stand-alone device which receives communication over the network from the controller PC to play audio.
b. A personal computer which has a software client which receives commands from the controller PC to play audio.
e) The controller PC software is a software application which contains a component to manage the devices and or PCs which will receive audio.
f) The software sends audio to the devices or PCs at scheduled times or in real-time.

2. An audio management system which organizes devices/remote PCs into audio zones for an intercom system:
a. A personal computer system running the system software. This personal computer may be a server, laptop, desktop, or PDA computer.
b. One or more devices or remote PCs.
c. Specialized software which has the following functions:
i. Allows users to group one or more devices into an audio zone.
ii. Plays audio to all devices in a zone when scheduled or as requested by the user.
iii. Allows zero, one, or multiple zones to be defined
iv. Allows users to add new zones
v. Allows user to remove and/or update existing zones.
